(19) United States
(12) Patent Application Publication
(10) Pub. No.: US 2025/0242680 A1
(43) Pub. Date: Jul. 31, 2025

(54) VEHICLE

(71) Applicant: TOYOTA JIDOSHA KABUSHIKI KAISHA, Toyota-shi (JP)

(72) Inventor: Yoshihiro MORITA, Okazaki-shi (JP)

(73) Assignee: TOYOTA JIDOSHA KABUSHIKI KAISHA, Toyota-shi (JP)

(21) Appl. No.: 18/923,959

(22) Filed: Oct. 23, 2024

(30) Foreign Application Priority Data
Jan. 26, 2024 (JP) 2024-010227

(51) Int. Cl. B60K 1/04

(52) U.S. Cl. CPC B60K 1/04; B60K 2001/0438

(57) ABSTRACT

The vehicle includes: an electric device housed between the seat and the floor panel; and a cover under the seat, the cover having a cavity configured to cover the upper and side of the electric device and to expose the lower portion of the electric device relative to the floor panel, the cover being fixed relative to the floor panel.

### CROSS-REFERENCE TO RELATED APPLICATION

This application claims priority to Japanese Patent Application No. 2024-010227 filed on Jan. 26, 2024, incorporated herein by reference in its entirety.

### BACKGROUND

### 1. Technical Field

The technology disclosed herein relates to a vehicle, and more particularly, to a vehicle, in a lower part of which an electric device is mounted.

### 2. Description of Related Art

In a vehicle, a battery module as a battery is occasionally mounted below a floor panel below a rear seat, for example. It is indicated that a charger that charges a battery module with electric power from an external power source is mounted above the floor panel (Japanese Unexamined Patent Application Publication No. 2023-68403 (JP 2023-68403 A)).

### SUMMARY

In general, a charger is housed in a case together with a cooling device that uses a liquid cooling medium for suppressing overheating of the charger. The case is composed of a lower case and an upper case, and sealed to suppress liquid leakage or the like from the cooling device.

When the charger is housed in the case and mounted on the vehicle, however, the number of parts in the vehicle increases. This may increase the cost, and decrease the working efficiency in the inspection or the like of the charger.

The present specification provides a technique of suppressing the number of parts and efficiently housing an electric device in a vehicle space with a simple structure.

The technique disclosed herein is embodied as a vehicle. The vehicle includes: an electric device housed between a seat of the vehicle and a floor panel; and a cover having a cavity configured to cover an upper side and a lateral side of the electric device below the seat and to expose a lower side of the electric device to the floor panel, the cover being fixed to the floor panel.

In this vehicle, the cover is fixed to the floor panel, so that a space for housing the electric device is defined between the seat lower side and the floor panel by the cover. Since a lower case is not provided unlike the related art, the number of parts can be reduced. Since a lower case is not provided, in addition, the work of attaching and detaching the electric device is simplified. Further, the space for housing the electric device is reduced, and the electric device is efficiently housed under the seat.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view showing a state of accommodation of a charger between a lower portion of a rear seat of a vehicle and a floor panel; and

FIG. 2 is a cross-sectional view showing a liquid-tight seal between a lower edge of a cover covering a charger and a floor panel.

### DETAILED DESCRIPTION OF EMBODIMENTS

The vehicle disclosed herein can include a cover having an electric device and a cavity. The electric device is housed between a seat and a floor panel of the vehicle. A cover covers the upper and side of the electric device below the seat and is secured to the floor panel. The cavity is configured to expose a lower portion of the electric device to the floor panel.

In one embodiment of the vehicle, the cover comprises a generally flat top wall, and the electric device is fixed relative to the top wall and housed in the cavity. In this way, as the cover is directly or indirectly fixed with respect to the floor panel, the electric device is also fixed with respect to the floor panel. Here, the term “substantially flat” means that there may be irregularities such as a bead for reinforcement, which does not hinder the fixing of the electric device.

One embodiment of the vehicle includes a seal member on a portion of the floor panel corresponding to a lower edge of the cover, and the lower edge is pressed against the seal member to provide a liquid-tight seal between the lower edge and the floor panel. In this way, a liquid-tight seal is easily formed between the floor panel and the cover under the cover. As a result, even if a liquid leak occurs at or near the electric device, the liquid leak to the outside of the cover on the floor panel is suppressed or avoided.

In one embodiment of the vehicle, the cover includes a bracket that extends obliquely upward from the lower edge and is fixed to a cross member of the vehicle. In this way, the cover can be easily fixed to the floor panel.

In one embodiment of the vehicle, the electric device includes a charger, and a secondary battery module is housed below the floor panel. In this way, the charger can be efficiently accommodated under the seat in the vicinity of the battery module. In addition, by doing so, leakage of liquid around the charger is suppressed from reaching the secondary battery module.

Hereinafter, embodiments of a vehicle disclosed in the present specification will be described with reference to the drawings as appropriate. In the present specification, upper, lower, front, rear, left, and right refer to the upper, lower, front, rear, left, and right of the vehicle, respectively, and are shown as UP, DW, FR and RR in the drawings. In addition, in the present specification, vehicles belong to a so-called electrified vehicle including a secondary battery pack as a driving battery or the like. Vehicles herein may include hybrid electric vehicle, fuel cell electric vehicle, solar cars.

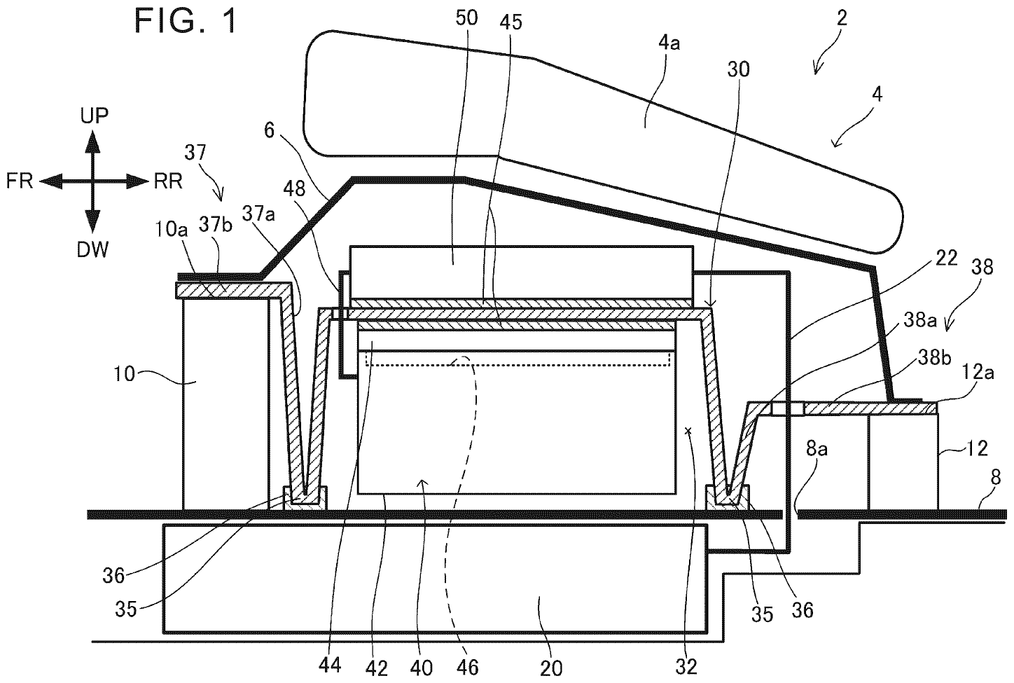

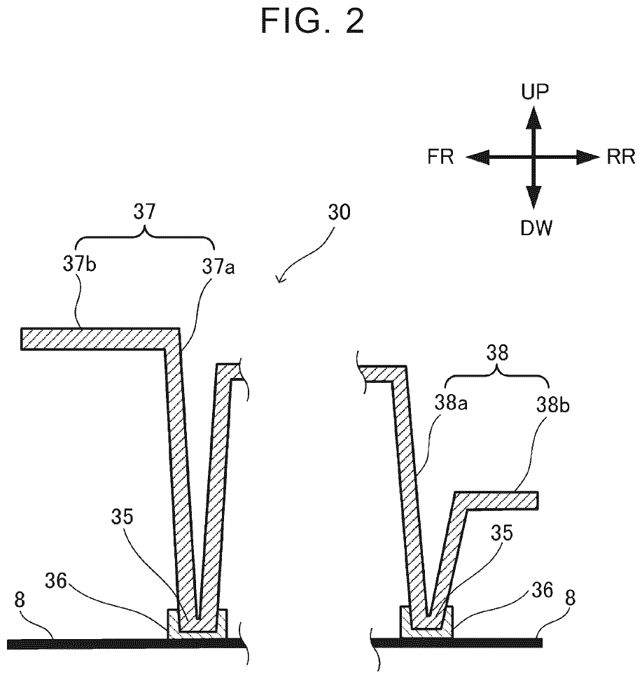

FIG. 1 shows the accommodation state of the charger 40 between the lower part of the rear seat 4 of the vehicle 2 and the floor panel 8, and FIG. 2 shows the liquid-tight seal state between the lower edge 35 of the cover 30 covering the charger 40 and the floor panel 8. In FIG. 1, a cross section of the rear seat 4, the battery pack 20, the in-vehicle charger 40, the cooling device 44, the relay box 50, and the like are omitted.

As shown in FIG. 1, in the vehicle 2, the rear seat 4 is disposed in the interior of the vehicle 2 together with a front seat (not shown). The rear seat 4 includes, in addition to a seat portion 4a in which the occupant lowers his/her waist, for example, a backrest portion that supports the back of the occupant and a headrest (both not shown) that supports the head of the occupant.

The seat portion 4a is supported from below by the seat frame 6. The seat frame 6 is fixed to the floor cross member 10 and the cross member 12 disposed rearward of the floor cross member 10. The floor cross member 10 extends along the width direction of the vehicle 2 and is fixed to the floor panel 8 or the like. The cross member 12 also extends along the width direction of the vehicle 2 and is fixed to the floor panel 8 or the like. For example, the seat frame 6 is fixed to the top 10a, 12a of each of the floor cross member 10 and the cross member 12 by screws or the like.

A battery pack 20 is mounted below the floor panel 8. The battery pack 20, for example, modularizes a plurality of secondary battery cells and is housed in a predetermined case. As the secondary battery, a known secondary battery such as a lithium-ion battery or a nickel metal hydride battery can be used. The battery pack 20 supplies electric power to a motor (not shown) or the like for driving the vehicle 2. Electric power generated by the motor by the in-vehicle charger 40, regenerative braking, or the like is supplied to the battery pack 20. The battery pack 20 is disposed at least below the floor panel 8 below the rear seat 4. The battery pack 20 may have a size that extends to a further enlarged area below the floor panel 8.

The battery pack 20 is connected to a relay box 50, which will be described later, by a cable 22 passing through the opening portion 8a of the floor panel 8.

A cover 30 is mounted between the seat portion 4a of the rear seat 4 and the battery pack 20 and between the floor cross member 10 and the cross member 12. The cover 30 houses an in-vehicle charger (hereinafter, simply referred to as a charger) 40. Floor cross member 10 and cross member 12 are examples of cross members disclosed herein.

Here, the charger 40 will be described. The charger 40 is accommodated below the seat portion 4a of the rear seat 4. The charger 40 receives electric power from an external power supply facility, for example, and converts the electric power into a current and a voltage corresponding to the battery pack 20. The charger 40 may be configured to be capable of supplying power to the outside. The charger 40 is disposed above the battery pack 20 with the floor panel 8 interposed between the floor cross member 10 and the cross member 12. The charger 40 is an example of an electric device disclosed herein.

The charger 40 includes a casing 42 that houses a connector with an external power supply facility, a AC/DC converter, a step-up DC/DC converter (neither of which is shown), and the like, and also includes a cooling device 44. The cooling device 44 is intended for cooling with a liquid medium such as water. The cooling device 44 allows the liquid medium to flow in or near the charger 40, and exchanges heat between the liquid medium and the heat from the charger 40. The cooling device 44 includes, for example, a plurality of concave flow channels 46 formed above the casing 42 of the charger 40. The flow channels 46 are configured such that a liquid medium is supplied from the cooling system, circulated, and eventually returned to the cooling system.

The cover 30 has a cavity 32 configured to cover the side of the charger 40 over the entire upper and outer circumferences thereof and to expose the lower portion of the charger 40 to the floor panel 8. That is, the cover 30 has a form like a downwardly opening, upside down container. The cover 30 is formed of, for example, a metal material, a resin material, or the like, but is not particularly limited thereto. The cover 30 includes a substantially flat top wall portion 33 and a cylindrical side wall portion 34 surrounding an outer peripheral edge thereof. The lower edge 35 of the side wall portion 34 has a peripheral shape surrounding the charger 40.

A seal member 36 is provided at a portion on the floor panel 8 corresponding to the lower edge 35. The seal member 36 is mounted on the floor panel 8 in a pattern corresponding to the peripheral shape of the lower edge 35. For example, in the case where the lower edge 35 has a substantially quadrangular peripheral shape, the seal member 36 is also mounted on the floor panel 8 so as to form a substantially quadrangular peripheral shape. The seal member 36 is formed of, for example, various elastomer materials such as rubber 20 and thermoplastic elastomer, or an elastic material formed of a resin material.

As shown in FIG. 2, the seal member 36 has, for example, a recessed shape corresponding to a tip portion of the lower edge 35 or a portion thereof. The lower edge 35 abuts against the concave shape of the seal member 36, and is pressed toward the floor panel 8 side, so that the space between the lower edge 35 and the floor panel 8 is sealed in a liquid-tight manner.

As shown in FIG. 1, a portion of the lower edge 35 is provided with brackets 37, 38. The brackets 37 include an extension 37a extending toward the floor cross member 10 and a mounting portion 37b abutting along the top 10a of the floor cross member 10. The 30 brackets 38 include an extending portion 38a extending obliquely rearward and a mounting portion 38b extending toward the top 12a of the cross member 12.

The brackets 37 are fixed to the top 10a of the floor cross member 10 in the mounting portion 37b by, for example, screws. The brackets 38 include mounting 38b that abut along the top 12a of the cross-member 12. The brackets 38 are fixed to the top 12a of the cross-member 12 in the mounting portion 38b, for example, by screws or the like. An opening through which the cable 22 passes is appropriately provided in the mounting portion 38b. The brackets 37, 38 secure the cover 30 such that the lower edge 35 can be pressed against the seal member 36 to provide a fluid-tight seal.

The charger 40 is housed in the cavity 32 of the cover 30. The charger 40 has an upper portion fixed to an inner surface (a surface facing the cavity 32) of the top wall portion 33 of the cover 30. By doing so, the charger 40 can be handled as a unit together with the cover 30. Although the casing 42 of the charger 40 may be fixed to the top wall portion 33, for example, as shown in FIG. 1, the cooling device 44 provided above the charger 40 may be fixed to the top wall portion 33. The fixing method is not particularly limited.

Further, for example, as shown in FIG. 1, the charger 40 may be fixed via a known heat insulating material 45 in order to ensure a cooling effect in the cooling device 44.

As shown in FIG. 1, when the charger 40 is fixed to the inner surface of the top wall portion 33 in the cavity 32, the charger 40 may be accommodated with a clearance above the surface of the floor panel 8 by a predetermined distance. This facilitates the operation of attaching the charger 40 as a unit together with the cover 30.

A relay box 50 is mounted on the top wall portion 33 of the cover 30. The charger 40 and the relay box are connected by a cable 48 through an opening appropriately provided in the top wall portion 33.

Next, the operation of the accommodation structure of the charger 40 in the vehicle 2 will be described. According to the above structure, the cover 30 covering the upper and side of the charger 40 is used to house and fix the charger 40. Since a case including a lower cover and an upper cover is used as in the related art, the number of parts can be reduced as compared with the conventional structure because the joining parts of the upper and lower covers are not used.

Further, the charger 40 is fixed to the floor panel 8 only by the cover 30, and further, since the liquid-tight seal can be established, the height along the vertical direction of the vehicle 2 required for accommodation of the charger 40 can be reduced, it is possible to efficiently accommodate the charger 40.

In addition, when the charger 40 is attached, it is sufficient to attach and detach the cover 30 to which the charger 40 is attached in advance to and from the vehicle 2. Therefore, the mounting operation of the charger 40 can be facilitated. In addition, work such as replacement and maintenance of the charger 40 or its peripheral components is facilitated. Simply removing the cover 30 from the vehicle 2 allows access to the charger 40 and its peripheral components. Therefore, it is easy to replace or maintain the charger 40 or its peripheral components.

Further, with the attachment of the cover 30, the lower edge 35 is pressed and fixed to the seal member 36 by the attachment of the cover 30. Therefore, a liquid-tight seal on the floor panel 8 is easily established. Even if liquid leakage of the liquid medium for cooling the charger 40 occurs, it is avoided that the liquid medium reaches the battery pack 20 disposed below the floor panel 8.

In the above embodiment, the brackets 37 and 38 are attached to the floor cross member 10 and the cross member 12 and fixed to the floor panel 8 as the fixing structure of the cover 30, but the present disclosure is not limited thereto. The cover 30 may thus be attached to the structural elements on the floor panel 8 and indirectly fixed to the floor panel 8, or may be directly attached to and fixed to the floor panel 8. The fixing structure of the cover 30 is appropriately configured according to the peripheral structure of the vehicle 2 to which the cover 30 is attached, and the like.

Although the charger 40 is exemplified as an electric device in the above embodiment, the electric device may be any electric device that is cooled by a liquid medium, such as a converter such as a DC/DC converter or a power converter such as an inverter.

Although the embodiments have been described in detail above, the embodiments are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of objectives at the same time, and achieving one of the objectives itself has technical usefulness.

What is claimed is:

1. A vehicle comprising:
an electric device housed between a seat of the vehicle and a floor panel; and
a cover having a cavity configured to cover an upper side and a lateral side of the electric device below the seat and to expose a lower side of the electric device to the floor panel, the cover being fixed to the floor panel.

2. The vehicle according to claim 1, wherein:
the cover includes a top wall portion having a generally flat shape; and
the electric device is fixed to the top wall portion and housed in the cavity.

3. The vehicle according to claim 2, further comprising a seal member provided on a portion on the floor panel corresponding to a lower edge of the cover, wherein
the lower edge is pressed against the seal member so that a liquid-tight seal is provided between the lower edge and the floor panel.

4. The vehicle according to claim 3, wherein the cover includes a bracket extending obliquely upward from the lower edge and fixed to a cross member of the vehicle.

5. The vehicle according to claim 4, wherein:
the electric device includes a charger; and
a secondary battery module is housed below the floor panel.
